(19) United States
(12) Patent Application Publication
(10) Pub. No.: US 2010/0043415 A1
(43) Pub. Date: Feb. 25, 2010

(54) EXTRUDED GAS COOLER

(76) Inventors: Andreas Capelle, Pulheim (DE); Peter Diehl, Koeln (DE); Stojan Cucuz, Koeln (DE)

Correspondence Address: FRASER CLEMENS MARTIN & MILLER LLC, 28366 KENSINGTON LANE, PERRYSBURG, OH, 43551, US

(21) Appl. No.: 12/539,673

(22) Filed: Aug. 12, 2009

(30) Foreign Application Priority Data
Aug. 12, 2008 (DE) DE 102008041189.2

(51) Int. Cl. F02M 31/20; F01N 3/02; F28D 7/10

(52) U.S. Cl. 60/320; 165/52; 165/154

(57) ABSTRACT

A device for cooling a gas stream of a combustion engine is disclosed, the cooling accomplished by means of a cooling medium with a housing in which at least a first channel is placed for conducting the gas flow through and a second channel for conducting the cooling medium through, whereby the first and the second channel are in thermal contact with each other. The housing includes an extruded part, in which at least one channel of the first and second channel are formed.

### CROSS-REFERENCE TO RELATED APPLICATION

This application claims the benefit of German Pat. Appl. No. DE 10 2008 041 189.2 filed Aug. 12, 2008, hereby incorporated herein by reference in its entirety.

### FIELD OF THE INVENTION

The subject of the present invention is a device for cooling a gas stream of a combustion engine by means of a cooling medium. The gas stream may, for example, be the exhaust gas of the combustion engine, which, to improve the exhaust parameters of the combustion engine, is returned via an exhaust return system to the inlet side of the combustion engine. For this, in many cases, a lowering of the exhaust temperature is required, for which a so-called exhaust return cooler (ERC) is used. Apart from that, the gas stream can be fresh air taken in by the combustion engine, which is pre-cooled to increase the efficiency of the combustion engine. This is especially significant when the fresh air taken in is compressed by means of suitable compressors like turbochargers or compressors, which goes hand in hand with increasing the temperature of the fresh air taken in.

### BACKGROUND OF THE INVENTION

For example, an ERC cooler is known from EP 1 277 945 A1. With this ERC cooler, a multiplicity of exhaust-bearing pipes is placed in a closed housing, which has a suitable cooling medium flowing through it, for example, from the coolant circuit of the combustion engine. With this, both the exhaust-bearing cooler pipe and also the housing surrounding it are configured as separate pieces that are securely connected to each other by placing suitable connection elements therebetween. Preferably with this, both the exhaust-bearing immersion pipes and also the housing are made of a corrosion-resistant, thermally stable material like high-grade steel.

What is disadvantageous from the structure previously known from EP 1 277 945 A1 is its assembly from a multiplicity of separate components. This results directly in an expensive assembly process, which implies cost disadvantages.

### SUMMARY OF THE INVENTION

It is, therefore, the task of the present invention to provide a device for cooling a gas stream of a combustion engine by means of a cooling medium that has a markedly lower number of mechanical parts, and therefore, is simpler to install. This problem is solved by a device with the features of the main claim.

Advantageous further embodiments are derived from the subordinate claims, whereby the advantageous further embodiments fundamentally may be freely combined with each other.

An invention-specific device cools a gas stream of a combustion engine by means of a cooling medium, with reference already having been made in the introductory part that the gas stream to be cooled may, for example, be the exhaust flow of the combustion engine, or also the fresh air taken in and compressed, which is passed to the combustion engine. The device comprises a housing, in which at least one first channel for guiding the gas flow through and a second channel for guiding the cooling medium through are placed. With this, the first and second channels are in thermal contact with each other, so that an energy exchange is possible between the cooling medium flowing through and the gas stream flowing through, to cool the gas stream. The combustion engine coolant can be considered for the cooling medium, but fundamentally, the invention-specific device can also be run with a coolant circuit separated from the combustion engine, to achieve lower operating temperatures, for example. The coolant circuit of a car air conditioner could be named as an example of this.

According to the invention, provision is now made that the housing of the device comprises at least one extruded part in which at least one channel of the first and second channels are created. In a first further configuration, both the first and second channels are created in the extruded part. With this, the extruded part may, for example, consist of aluminum and be so configured that with no additional mechanical components, completely closed first and second channels are formed.

As can be gleaned more exactly from the embodiment examples, in this way, a device for cooling a gas stream of a combustion engine (i.e., a cooler) can be prepared that is based on a minimum number of mechanical components, that have to be fitted together when the device is installed. In addition, at least the extruded part is easy to manufacture at low cost. Manufacturing using extruding additionally offers an advantage in that the extruded part may vary greatly in its profile. Lastly, the extruded part, at least directly after being extruded, can easily also be deformed regarding its longitudinal axis L, resulting in great degrees of freedom regarding the shaping of the invention-specific cooler.

In a further embodiment, the housing of the device includes a separately shaped jacket piece in which the extruded part is placed. Especially the device can be so embodied that the first and second channels are only configured as closed channels when the extruded part is arrayed in the jacket piece. By providing a press fit of the extruded part in the jacket piece, for example by means of interference fitting, a long-term-stable mechanical connection can be assured between the pressed piece and the jacket piece. With this, the jacket piece and the extruded piece may consist of the same material such as aluminum or an aluminum or magnesium alloy. But the jacket piece and the extruded piece may also consist of differing materials. This especially offers advantages, if, due to the shaping of the extruded piece (such as arranging the first and second channels), a markedly different thermal loading of the jacket piece and the extruded piece can be ensured. Thus, in a configuration in which the jacket piece is in direct contact with the second channel or channels guiding the cooling medium, a slight thermal loading of the jacket piece can be ensured. Here especially, it is possible to manufacture the jacket piece from a material that has a lower capacity to be thermally loaded than the extruded piece, for example, a plastic. In advantageous fashion, this is a plastic with increased thermal stability, especially a duroplast.

Additionally, separation of the housing of the invention-specific device into at least one extruded part and one jacket part offers advantages regarding deformability of the device perpendicular to longitudinal axis L of the extruded part or of the housing. Surprisingly, it has been shown that a housing thus structured of at least two parts can be deformed mechanically in simple fashion so that longitudinal axis L of the housing deviates from a straight line. From this, there results an advantage in that the shaping of the invention-specific device can be largely adapted to vehicle-specific requirements, from which direct design-space advantages arise. Good deformation capacity perpendicular to longitudinal axis L of the housing also fundamentally exists in a one-piece-configured housing in the form of an extruded part 20.

Additionally, theoretical and experimental trials have shown that advantages accrue in regard to the efficiency of the invention-specific device if at least the first or the second channel, or both channels, are so configured to result in a helical flow path for the gas stream or the stream of the cooling medium. The resultant turbulence in the gas flow or in the flow of the cooling medium provides for especially intensive mixing of same, and thus, for improved heat transfer from the heat exchanger surfaces through which energy exchange occurs between the two material streams. In a particularly easy way, a helical flow path can be formed by giving overall torque to the extruded part of the invention-specific device. If both the first and the second channels are formed in the extruded part, then here, helically wound flow paths are directly formed in both channels.

Of course, versions are conceivable in which in fact only a first channel for the gas stream and a second channel for the cooling medium are formed in the housing. However, favorable results have been obtained if a multiplicity of first and/or second channels is formed in the housing. This can occur, for example, in simple fashion by placing a multiplicity of separating fins or walls within the first and/or second channels, which divides the first or second channel into a multiplicity of channels separated from each other.

In a further embodiment, the housing has a longitudinal axis L. With this, at least on a long-sided end, i.e. on a surface running transverse to longitudinal axis L, the housing is closed by means of a separately formed end cap. In this separately formed end cap, at least one access to the first channel or channels is formed. Advantageously, on both long-sided ends of the housing, appropriate end caps are placed in which accesses to the first channel or channels are formed. In an alternative embodiment, in at least one end cap, an additional access to the second channel or channels is formed in the housing. Preferably, two end caps are provided, in each of which are formed an access to the first channels and an access to the second channels. In all of the embodiments, the end caps are typically connected by means of a thermal joining process like soldering or welding with the housing. However, depending on the thermal loading of the invention-specific device, a joined connection by means of adhesive bonding is possible. In addition, the end caps can be detachably connected mechanically with the housing, for example, by means of a suitable screw connection while inserting suitable thermally stable seals like a metallic seepage seal.

In yet another embodiment of the invention-specific device, an access to the second channel or channels is not formed at one or both end caps, but rather, outside the end cap on the housing of the device. If need be, separately configured attachment pieces can be provided which allow attachment of the invention-specific device to the coolant circuit, for example, the coolant circuit of the combustion engine. These attaching pieces can be separately formed parts made of aluminum die casting or again as extruded parts, and snugly connected in a suitable manner to the housing of the device, for example, by means of a materials-flow connection like soldering, welding or gluing, or a form-locking connection like a screw connection.

Particular advantages accrue if the access to the two channels—independent of its specific placement on the device—as well as a multiplicity of second channels in the housing is so configured that the access simultaneously communicates with all of the second channels. Two equivalent accesses to the second channels can be implemented, so that via one inlet and one outlet, a uniform feeding of all the second channels with the cooling medium is ensured.

If a multiplicity of first channels is provided for the gas stream to be cooled, then here also it is true that the accesses to the first channels can be so configured that via one access all first channels are able to be reached at the same time, so that via a connection, for example, with the exhaust line of the combustion engine, it is possible simultaneously to attach the invention-specific device.

In yet another further development of the invention-specific device, within the first channel, for guiding through the exhaust stream to be cooled, a third channel is arranged, that again is placed to conduct the cooling medium through. In particular, the first and the third channel can in essence be placed coaxial to each other. In this embodiment example, there results especially simple attachment options for the invention-specific device, if the third channel communicates with the second channel in such a manner that the stream of cooling medium inducted on the inlet side is divided between the second and third channel. Here, the division ratio can be freely set within wide limits by appropriate flow configurations of the connections, especially to adapt the local flow of the cooling medium through the second or third channels to the local thermal yield.

A particularly small number of mechanical parts results, if the third channel again is formed in one piece with the extruded part of the housing, especially the first, second and third channel can be formed advantageously with the extruded part, in such a manner that no further mechanical component is necessary to close the first, second and third channel to be substantially impermeable to gas or liquid.

Alternatively, the third channel can be configured as a separate component from the extruded part, which overall can have advantages regarding selection of material or deformability of the invention-specific device. Since the third channel, for example, can be placed in the particularly hot center of the gas stream to be cooled, here it can be advantageous to use a particularly thermally stable and corrosion-resistant material for the third channel such as high-grade steel. If the third channel is configured as a separate component, then a mechanically captive connection between the extruded part and the third channel can be implemented, for example, via a compression fitting of both parts.

Optimization of the material selection as regards the local temperature and corrosion conditions permits an embodiment of the invention-specific device, in which an extruded part (made, for example, out of aluminum) is placed, in which a separately formed third channel is formed, for example, as a high-quality steel tube situated in the middle. The extruded part, for its part, is surrounded by an outer jacket part made, for example, of plastic, whereby, for example, the second channels can be configured. Here also, a mechanically captive connection can be provided between the third channel, the extruded part and the jacket part via a particular compression fitting.

Since the temperature of the gas stream to be cooled can depend on the operating conditions of the combustion engine, insertion of a fourth channel for undistorted conduct of the gas stream through the housing of the invention-specific device can be advantageous. With this, the gas stream should be conducted through the housing so that in essence, there is no thermal exchange with the cooling medium.

Such a fourth channel, thermally isolated at least vis-a-vis the second or if need be the third channel, which is also designated as a “bypass line,” is especially advantageous in the cold-start phase of the combustion engine, in which it is desired that the engine, or of components that guide the exhaust or treat it, be heated as quickly as possible. With this, also the fourth channel can advantageously be embodied as a separate component which is placed in the extruded part of the housing. This separate component in turn can consist of another material than the extruded part, especially of a thermally stable and corrosion-resistant steel. Advantages accrue regarding the thermal insulation of the fourth channel against the housing of the invention-specific device, here, especially against the second and perhaps the third channel in the housing, if in essence the fourth channel rests only mechanically via defined contact points on the extruded piece and/or jacket piece. Here, for example, the fourth channel embodied as a separate pipe may form spring-loaded tongues, via which the pipe is braced against the surrounding components.

Lastly, another embodiment is possible in which the gas-bearing first channel runs totally in the extruded profile, and there is closed to seal against gas. The extruded part can then be bent by about 180° in the form of a U profile, to which then a separate fluid housing of cost-effective material can be arranged. The gas attachment is then made on the front side, the cooling medium can flexibly be made on the front and/or the housing side.

In all embodiments, the extruded profile can fundamentally assume varied cross sections such as round, oval, rectangular, etc.

Use of the invention-specific cooler as a charging-air cooler, as well as an ERC cooler, was already indicated as possible uses. However, additionally, usage is possible as a heater for warming a vehicle's passenger compartment, use as a condenser, for conducting a coolant designed as a medium capable of condensation, as a condenser, for conduction of a gas stream designed as a medium capable of condensation, as an oil cooler, for cooling motor oil and/or transmission oil, as well as a refrigerant cooler or refrigerant condenser in a refrigerant circuit of a motor vehicle.

### BRIEF DESCRIPTION OF THE DRAWINGS

Further advantages and features of the invention are derived from the subordinate claims, which are explained in greater detail in what follows with the aid of the drawings. Shown in them are.

FIG. 1: a perspective depiction of a first embodiment example of an invention-specific cooler.

FIG. 2: a partial cross section depiction of the cooler from FIG. 1.

FIG. 3: a perspective exploded view of the cooler from FIG. 1.

FIG. 4: an enlarged view of the extruded part of the cooler from FIG. 1.

FIG. 5: the cross section of the extruded part of the cooler from FIG. 1.

FIG. 6: a section through a long-sided end of the extruded part of the cooler from FIG. 1 with the end cap placed on.

FIG. 7a: a section through the long-sided end of the extruded part of a cooler with an alternative end cap.

FIG. 7b: a perspective drawing of the long-sided end of the extruded part of the cooler according to FIG. 7a.

FIG. 8: a perspective view of a long-sided end of the extruded part of the cooler from FIG. 1 with an inserted inlet sleeve.

FIG. 9: a perspective drawing of a third embodiment example of an invention-specific cooler.

FIG. 10a: a schematic depiction of the flow of the cooling medium through the second channels of the cooler according to FIG. 9.

FIG. 10b: a schematic depiction of the gas flow through the first channels of the cooler according to FIG. 9.

FIG. 11: a perspective drawing of a fourth embodiment example of an invention-specific cooler.

FIG. 12: a perspective drawing of a fifth embodiment example of an invention-specific cooler.

FIG. 13: a section through the cooler according to FIG. 12.

FIG. 14: the profile of the extruded part of the cooler according to FIG. 12.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

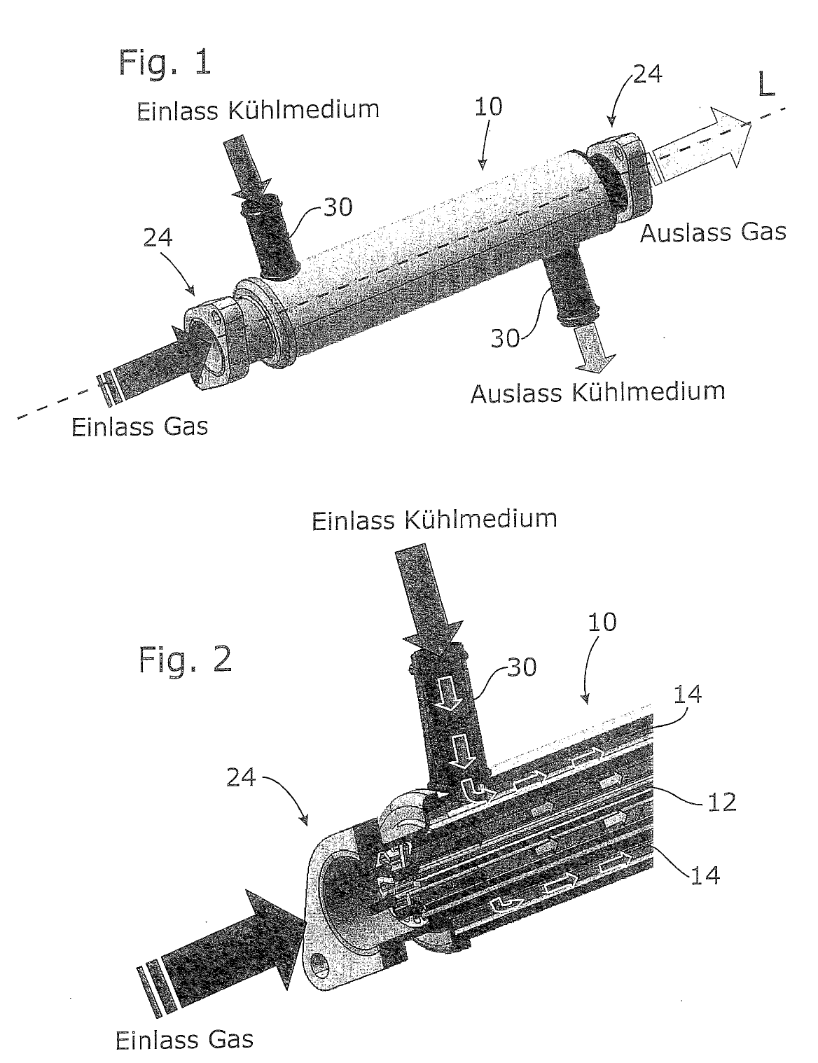

FIG. 1 shows a first embodiment example of an invention-specific device 1 which is a cooler for cooling a gas stream of a combustion engine using a cooling medium. The cooler 1 includes a housing 10, which has a longitudinal axis L. On the long-sided ends of housing 10, end caps 24 are placed and connected to be impervious to gas and liquid with housing 10. Each of the end caps 24 form an access 26 to the first channel 12, which is provided for the gas stream to be cooled to flow through and is formed in housing 10 (not shown in FIG. 1). Additionally, on the outer circumferential surfaces of housing 10, attachment pieces 30 are placed, that make possible accesses 28 to a multiplicity of second channels 14, which extend in housing 10 essentially in the direction of longitudinal axis L and are provided for the cooling medium to flow through. With this, a first one of the end caps 24 forms the gas inlet, a second one of the end caps 24 forms the gas outlet. A first one of the attachment pieces 30 forms the inlet for the cooling medium, a second one of the attachment pieces 30 forms the outlet for the cooling medium.

FIG. 2 is a partial sectional depiction of cooler 1 according to the first embodiment example according to FIG. 1. From the partial sectional depiction, the first channel 12 is evident, for which end cap 24 makes available an access 26. The access piece 30 makes available an access 28 to a multiplicity of second channels 14, that are placed around the central first channel 12. As is further evident from FIG. 2, end cap 24 closes the long-sided ends of the second channels 14, thus precluding passage of the cooling medium over into the gas stream to be cooled.

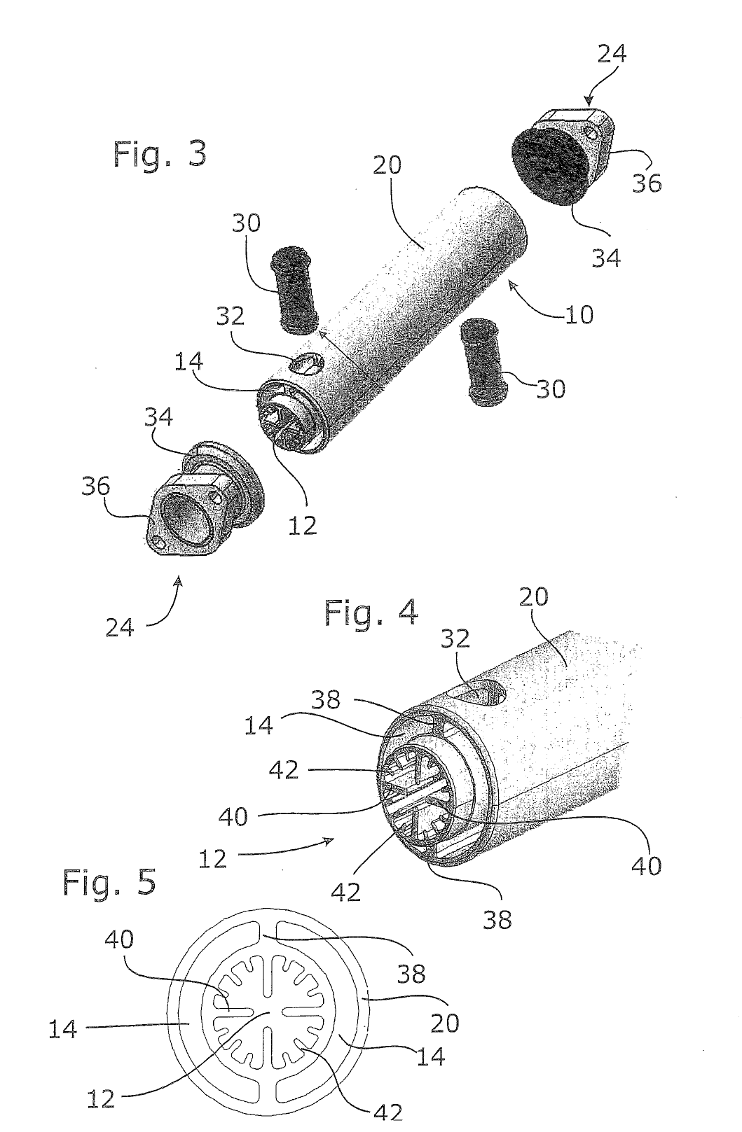

FIG. 3 is an exploded depiction of cooler 1 according to the first embodiment example according to FIG. 1. It is clearly evident that the entire cooler 1 is composed of a few mechanical components, namely housing 10, configured as a one-piece, extruded piece 20, two attachment pieces 30 connected to seal against gas and liquid impingement with housing 10, as well as two end caps 24 placed on the long-sided ends of housing 10, with the end caps 24 for their part consisting of two pieces, as is described in what follows again in greater detail. The extruded part 20 which forms housing 10 and in which a centrally running first channel 12 and two second channels 14 that are placed about first channel 12 extend, may be formed of aluminum, just like attachment pieces 30, which in the embodiment example shown are configured as die casting parts and are connected so as to be sealed against gas and liquid impingement with extruded part 20 via a thermal jointing process.

FIG. 5 is a cross section of the extruded part 20 from FIG. 3, which forms housing 10. Clearly visible in the center of extruded part 20 is first channel 12 extending in a longitudinal direction, in which a multiplicity of small cooling fins 42 as well as large cooling fins 40 are provided for an increase of the wall surface for heat exchange between first channel 12 and the second channels 14. About first channel 12, two second channels 14 are arranged, which are separated from each other by means of two walls 38. With this, both the walls 38 and also the smaller and larger cooling fins 42, 40 are shaped in when part 20 is extruded.

As already explained, access 26 to first channel 12 is made possible via the end caps 24. Access 28 to the second channels 14, in contrast, is made via a borehole 32, which is formed in the exterior wall of housing 10. This is evident from FIG. 4. With this, borehole 32 is so placed on housing 10, that in sectional fashion it opens one of the two walls 38 placed between the two channels 14 and in this way provides a flow transfer opening 52 between the two second channels 14.

Borehole 32, as well as flow transfer opening 52, is similarly made in the area of both attachment pieces 30. In this way, via an attachment piece 30, an access 28 can be provided parallel to the two second channels 14, with a uniform division of the flow of the cooling medium being ensured through the two second channels 14 due to symmetrical placement of borehole 32. As is clear from FIG. 3, the two attachment pieces 30 are placed on opposite sides of housing 10, to ensure that the cooling medium flows around the central first channel 12.

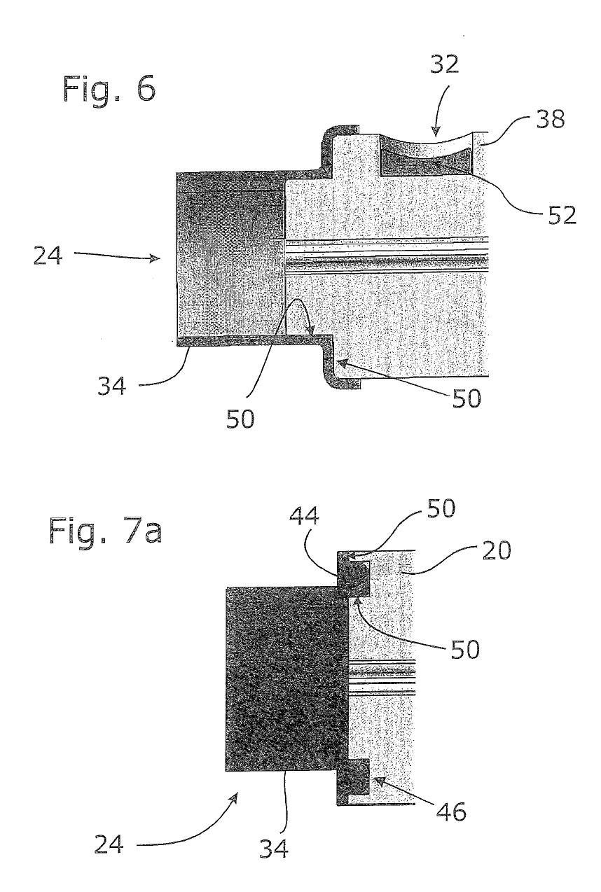

FIG. 6 then shows a long-sided end of housing 10 of the cooler in a schematic section depiction with end cap 24 placed on. End cap 24 consists of a sheath 34, whose end on the housing side is expanded to form a flange 36. Flange 36 of sheath 32 is so configured that it overlaps the long-sided end of extruded piece 20 On its long-sided end, extruded piece 20 forms two planar-processed sealing surfaces 50, on which sheath 34 sits with its interior circumferential surface as well as the flange surface. When invention-specific cooler 1 is assembled, sheath 34 is connected in material-locking form with extruded piece 20 to seal against fluids, for example by soldering, with the gas- and liquid-sealed connection formed essentially in the area of sealing surfaces 50.

Additionally, from FIG. 6 again borehole 32 is visible, into which attachment piece 30 is inserted, to make an access 28 to the second channels 14. Here, it becomes clear how borehole 32 opens the flow transfer orifice 52 in wall 38, that is placed between the two second channels 14.

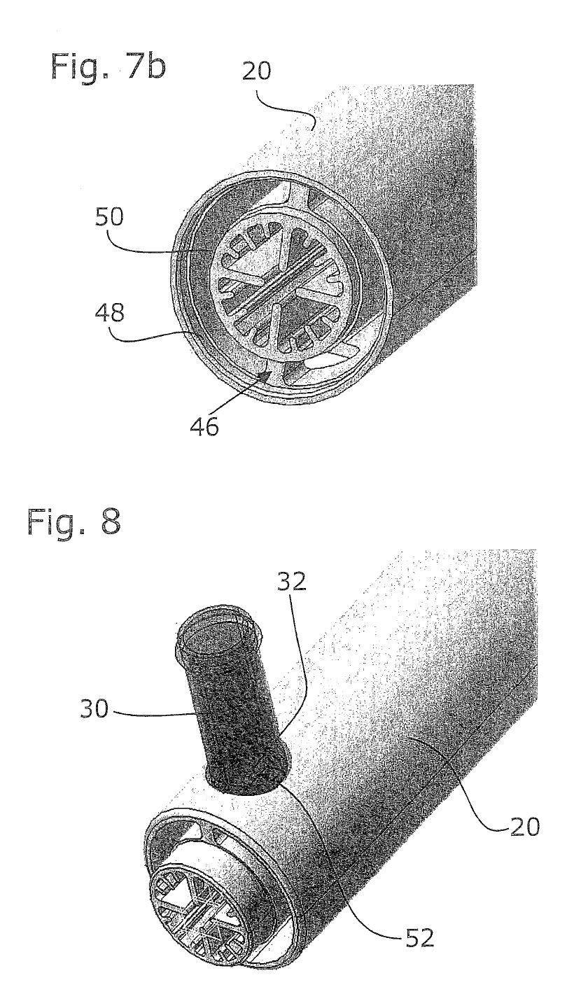

FIG. 7a shows an alternative embodiment of an end cap 24 as well as of an extruded part 20 (second embodiment example). Here also, end cap 24 is surrounded by a sheath 34, whose end 44 on the housing side is flanged, however. Further, an annular groove 46 is placed into the long-sided end surface of extruded part 20, whose inner circumferential surface is configured as sealing surface 50. In addition, the annular outer surface of the long-sided end surface of extruded part 20 is likewise configured as a sealing surface 50. When invention-specific cooler 1 is assembled according to this embodiment example, sheath 34 with its flanged end 44 is inserted into annular groove 46 and connected so as to seal against gas and liquid by materials flow with the long-sided outer surface of extruded part 20, by soldering, for example. As can be gleaned from FIG. 7b, on the outer wall of the second channels 14, in the area of the long-sided end surfaces of the housing 10, in addition, to increase sealing action, a surrounding projecting sealing lip 48 is formed, which promotes closure of the two channels 14 by sheath 34 so as to seal against permeation of gas and liquid, working in concert with the flanged end 44.

FIG. 8 again shows the extruded part 20 of cooler 1 according to the first embodiment example with attachment piece 30 inserted into borehole 32. From the dashed line illustration of attachment piece 30, the flow transfer opening 52 in wall 38 is visible, which separates the two second channels 14 from each other. As already mentioned, the flow transfer opening 52 makes possible even division of the flow of cooling medium to the two second channels 14.

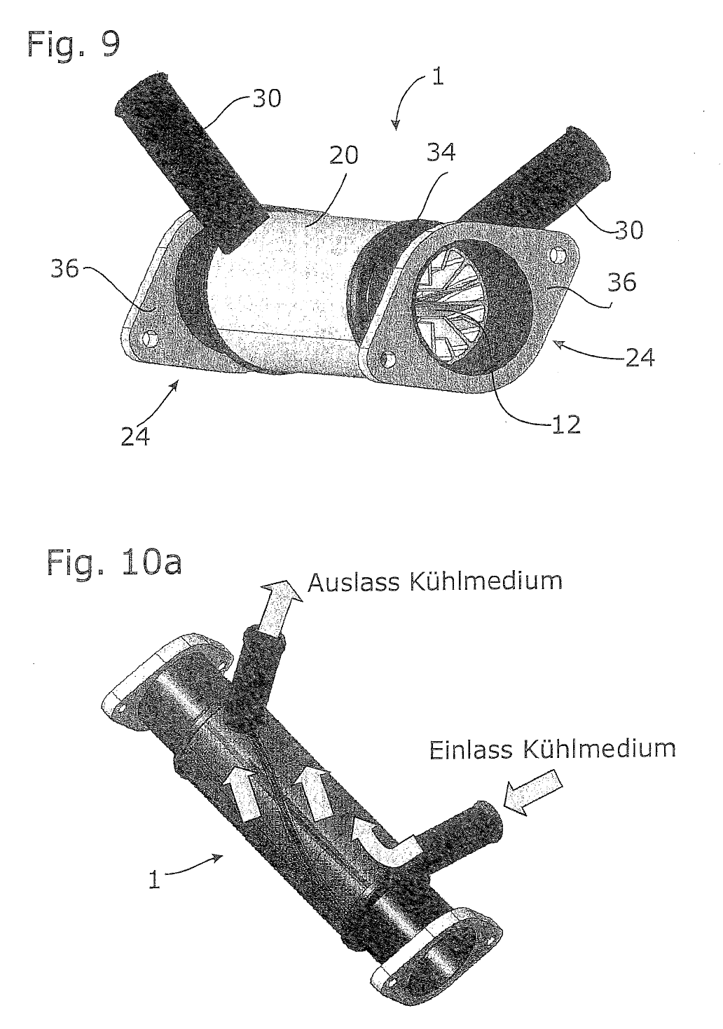

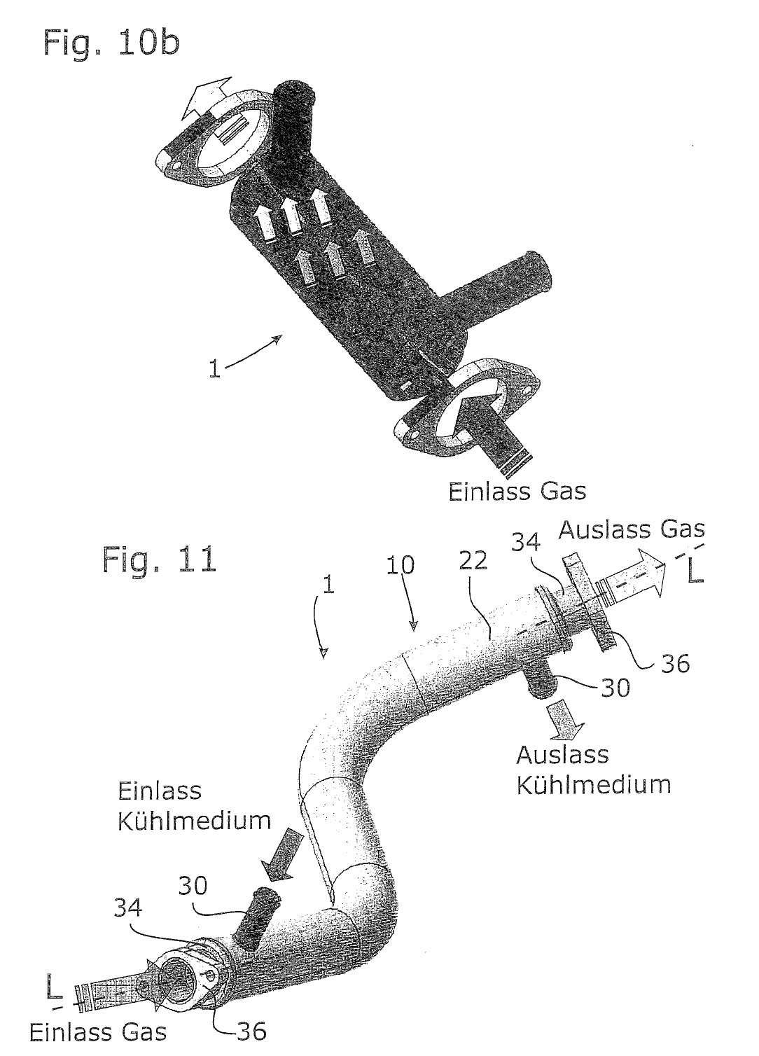

FIG. 9 shows a third embodiment example of an invention-specific cooler 1, which is distinguished by a spirally wound flow path both of the flow of the cooling medium and also of the gas stream to be cooled. Fundamentally, the design of cooler 9 according to FIG. 9 essentially corresponds to the design of cooler 1 from FIG. 1, with the attachment pieces 30 now displaced by about 90° from each other, and no further than by 180° as in the first embodiment example. In addition, housing 10 is again configured as a one-piece, extruded part 20, for example of aluminum, which is closed by two end caps 24. The wound flow paths are now provided by having the entire extruded part 10 twisted in controlled fashion about a defined angle while it is produced, or possibly also at a later time. In the embodiment example shown, the twisting between the two boreholes 32, into which attachment pieces 30 are placed, amounts in essence to 90°. From this there results a spirally wound flow path for the cooling medium in the two second channels 14, as is schematically shown in FIG. 10a.

In contrast, FIG. 10b shows the spirally wound flow path of gas flow in first channel 12 of housing 10, with the sheath 34 of end caps 24 left off for clarification. The wound flow paths for the two flowing media implemented in this way make for an interior vorticity of these media in flow channels 12, 14 made available, and thus, for an effective heat equalization within each flowing medium. This thermal equalization within the one flowing medium is advantageous for an effective heat transfer between the gas and the cooling medium.

FIG. 11 shows a fourth embodiment example of an invention-specific cooler 1, whose design again corresponds in essence to that of the embodiment example according to FIG. 1. Here the difference is the considerably increased length of housing 10, as well as the fact that the longitudinal axis L of housing 10 no longer forms a straight line. Rather, the longitudinal axis L of housing 10 is wound, to adapt it to the spatial requirements of the specific purpose for which cooler 1 is used. In addition, housing 10 in the embodiment example shown is not configured as a one-piece extruded piece 20. Rather, housing 10 here includes an extruded piece 20 that is placed inside a jacket part 22, and is secured in it via a compression fitting. After insertion of extruded part 20 (in which a first channel 12 is placed) into jacket part 22, housing 10, thus configured, is deformed and then closed by means of the front-side end caps 24. The separate formation of extruded piece 20 and jacket piece 22 improves the deformability of housing 10 transverse to longitudinal axis L. Jacket piece 22 may consist of a different material than extruded part 20. The second channels 14 are only fully formed in the fourth embodiment form shown when extruded piece 20 is inserted into jacket piece 22. Naturally, it is also possible in this embodiment example to form spirally wound flow paths in the first and second channels 12, 14, for example by twisting extruded piece 20. In addition, also in this embodiment example, end caps 24 according to the two configurations of FIG. 6 or 7a and 7b can be used.

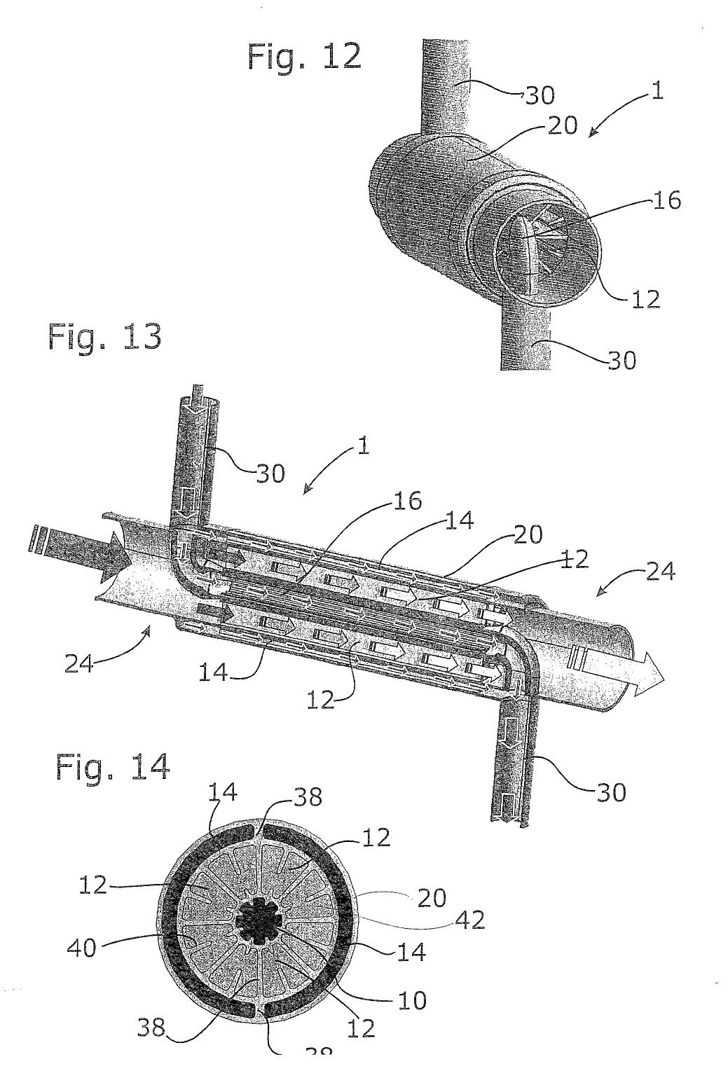

Lastly, FIGS. 12 to 14 show a fifth embodiment example of an invention-specific cooler 1, that is distinguished by a third channel 16, that is placed in the center of first channel 12, coaxial to it, and is provided for the cooling medium to flow through. Here, the housing 10 is again configured as an extruded part 20, i.e., a separately formed jacket piece 22 is not provided. The extruded piece 20 in turn is closed to seal against impingement of gas and liquid on the long-sided ends by means of suitably formed-out end caps 24. In contrast to the previous embodiment examples, in the center of first channel 12, as mentioned, a third channel 16 is formed, that again is formed integrally with the extruded part 20.

FIG. 14 shows a cross section through extruded part 20 of this fifth embodiment example, from which it can be seen that in the center of extruded part 20, the third channel 16, with cooling medium flowing through, is surrounded by a multiplicity of first channels 12 with gas flowing through. With this, these first channels 12 are separated from each other by walls 38, that are integrally formed with extruded part 20. Further, in each first channel 12, small and large cooling fins 42, 40 are created. Lastly, two second channels 14 are arranged to surround first channel 12, which in essence, correspond to the second channels 14 of the previously discussed embodiment examples.

However, in a departure from the previously discussed embodiment examples, the end caps 24 are so configured that they provided accesses both to first channels 12 and to second and third channels 14 and 16. For this, attachment pieces 30 are likewise provided on end caps 24, that allow fluids to connect both with the two channels 14 and also with third channel 16.

FIG. 13 shows the flow progression both of the gas stream to be cooled in first channels 12 and also of the flow of cooling medium in second and third channels 14, 16. This embodiment is especially suited for large cross sections of housing 10, in which otherwise difficulties would arise with deficient cooling of the gas flowing in the center of the exhaust channel. In this embodiment, the flowing exhaust gas is cooled both along the inner and the outer circumferential surfaces of first channels 12. As before, this embodiment form can be combined with a separately formed jacket piece 22. Additionally, it can also be combined with a separately formed fourth channel 16, for example in the form of a pipe placed in the center of first channel 12, made for example of a heat-resistant and corrosion-proof steel. Finally, this embodiment form also can be provided, for example, by torsion of extruded part 20 to produce spirally wound flow paths both for the gas to be cooled and also for the flow of the cooling medium.

From the foregoing description, one ordinarily skilled in the art can easily ascertain the essential characteristics of this invention and, without departing from the spirit and scope thereof, can make various changes and modifications to the invention to adapt it to various usages and conditions.

### REFERENCE SYMBOLS

1 Device
10 Housing
12 First channel
14 Second channel
16 Third channel
18 Fourth channel
20 Extruded part
22 Jacket piece
24 End cap
26 Access to first channel
28 Access to second channel
30 Attachment piece
32 Borehole
34 Sheath
36 Flange
38 Wall
40 Large cooling fins
42 Small cooling fins
44 Flanged end
46 Annular groove
48 Sealing groove
50 Sealing surface
52 Flow transfer opening
L Housing longitudinal axis

What is claimed is:

1. A device for cooling a gas stream of a combustion engine with a cooling medium, the device comprising:
a housing formed by an extrusion process, the housing having a first channel and a second channel formed therein, the first channel conveying the gas stream and the second channel conveying the cooling medium, wherein the first channel and the second channel are in thermal contact.

2. The device according to claim 1, wherein the first channel and the second channel are formed during the extrusion process.

3. The device according to claim 1, further comprising a jacket part disposed around the housing.

4. The device according to claim 3, wherein the housing is mechanically connected with the jacket part by compression fitting.

5. The device according to claim 3, wherein jacket part and the housing consist of the same material.

6. The device according to claim 3, wherein the jacket part and the housing consist of differing materials.

7. The device according to claim 3, wherein the jacket part consists of a plastic.

8. The device according to claim 1, wherein at least one of the first channel and the second channel form a helical-shaped flow path.

9. The device according to claim 8, wherein the housing is twisted.

10. The device according to claim 1, wherein the housing includes an end cap disposed on an end thereof to form an inlet to the first channel.

11. The device according to claim 10, wherein the end cap is connected to the housing by a thermal fitting process.

12. The device according to claim 10, wherein the end cap is detachably connected to the housing.

13. The device according to claim 10, wherein the housing includes at least one inlet formed therein to the second channel.

14. The device according to claim 1, wherein a third channel is formed in the housing for conveying the cooling medium.

15. The device according to claim 14, wherein the third channel is a fluid communication with the second channel.

16. The device according to claim 14, wherein the third channel is formed during the extrusion process.

17. The device according to claim 1, wherein the housing has a longitudinal axis L that is not linear.

18. A device for cooling a gas stream of a combustion engine with a cooling medium, the device comprising:
an extruded housing having a first channel and a second channel formed therein, the first channel adapted to convey the gas stream and the second channel adapted to convey the cooling medium, wherein the first channel is in thermal communication with the second channel.

19. The device according to claim 18, wherein the housing is twisted to form an irregular flow path in at least one of the first channel and the second channel

20. A device for cooling a gas stream of a combustion engine with a cooling medium, the device comprising:
an extruded housing having a first channel, a second channel, and a third channel adapted to convey the gas stream and the second channel and the third channel adapted to convey the cooling medium, wherein the first channel is in thermal communication with at least one of the second channel and the third channel.
